(19) United States
(12) Patent Application Publication
(10) Pub. No.: US 2008/0043305 A1
(43) Pub. Date: Feb. 21, 2008

(54) Deflection scanner for laser projection system of mobile terminal

(75) Inventors: Sang Jae Song, Gyunggi-do (KR); Ho Lee, Gyunggi-do (KR); Young Jin Bae, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/806,454

(22) Filed: May 31, 2007

(30) Foreign Application Priority Data
Jun. 27, 2006 (KR) 10-2006-0058143

(51) Int. Cl. G02B 26/10

(52) U.S. Cl. 359/198

(57) ABSTRACT

Disclosed herein is a deflection scanner for the laser projection system of a mobile terminal. The deflection scanner includes a rotating axis, a magnet, at least one pair of armatures, at least one detection sensor, and a circuit board. The rotating axis is configured to reciprocally rotate a reflecting mirror by a predetermined angle. The magnet is installed to be fastened to the rotating axis and is configured to form a predetermined magnetic field. The armatures are installed at the circumference of the magnet to be spaced apart from each other. The detection sensor configured to detect the rotational displacement of the rotating axis by detecting variation in a magnetic field of the magnet. The circuit board is installed such that the detection sensor and the armatures are electrically connected to each other, and is configured to electrically control the armatures using the output voltage of the detection sensor.

### CROSS REFERENCE TO RELATED APPLICATION

This application claims the benefit of Korean Patent Application No. 10-2006-0058143, filed on Jun. 27, 2006, entitled “Deflecting Scanner Installed in a Laser Projection System for Hanset,” which is hereby incorporated by reference in its entirety into this application.

### BACKGROUND OF THE INVENTION

1. Field of the Invention

The present invention relates generally to a deflection scanner and, more particularly, to a deflection scanner, which is small enough to be installed in the laser projection system of a mobile terminal.

2. Description of the Related Art

Currently, the mobile communication terminal market exhibits a trend of providing functions for providing various types of service other than voice communication or text messaging service, for example, moving image service, game service and route finding service, in a mobile terminal. In particular, as a terminal, such as a Digital Multimedia Broadcasting (DMB) phone, which enables TV programs to be viewed while being carried, has been marketed, demands for a mobile terminal, which has a small size so that it can be easily carried and which also has a large-sized screen so that it can be comfortably viewed, are increasing. In order to meet the demands for the small size and the large-sized screen, research into a mobile terminal in which a laser projection system is provided is being actively conducted.

Such a laser projection system includes a polygonal rotating mirror, which is used to reflect a light beam while rotating reciprocally by a predetermined angle to scan the light beam, which enters from a light source. The polygonal rotating mirror is driven by a deflection scanner, such as a motor. Furthermore, the laser projection system includes a rotating axis or a detection means, which is used to detect the rotational displacement of the polygonal rotating mirror, to reciprocally rotate the deflection scanner.

As an example of the deflection scanner installed in the above-described laser projection system, there is a “Galvanometer Provided with Magnetic Sensor,” which was disclosed in Japanese Unexamined Pat. Publication No. 2004-361268.

As shown in FIG. 4, a conventional galvanometer 1 includes a cylindrical galvanometer main body 2, an axis 4 configured to protrude from the section of the axis side of the galvanometer main body 2 and configured such that the rotation thereof is controlled, a disc 3 installed on the section of the counter axis side of the galvanometer main body 2, an arm 5 connected with an end portion of the counter axis side of the axis 4 and configured to protrude in a radial direction, and a head 6 installed at the end of the arm 5.

The disc 3 is a circular plate which is made of non-magnetic material, such as aluminum or glass, and has a through-hole formed in the center portion thereof. Furthermore, the surface layer of the disc 3 is formed of a magnetic layer. The end portion of the counter axis side of the axis 4 protrudes from the through-hole, and the arm 5 is connected to the end portion. Furthermore, the head 6, which is used as a magnetic sensor, is installed at the end of the arm 5, and the head 6 rotates synchronously with the rotation of the axis 4.

As shown in FIG. 5, in the circumferential portion of the disc 3, that is, in an annular region 30 corresponding to the head 6, which rotates, a predetermined gap is formed and magnetized sections 31 and 32 are alternately formed at regular intervals. Furthermore, each of the magnetized sections 31 and 32 is formed such that that the circumferential width h of the magnetized section thereof is the same as the width H of the head 6. The magnetized direction of the magnetized section 31 differs from the magnetized direction of the magnetized section 32, as indicated by arrows. That is, the magnetized section 31 is magnetized such that the radially central portion thereof has N polarity, and the central side and circumferential side thereof have S polarity. In contrast, the magnetized section 32 is magnetized such that the radially central portion thereof has S polarity, and the central side and circumferential side thereof have N polarity.

In the galvanometer having the above-described construction, the disc 3 is installed on the main body 2 to detect the rotational displacement of the axis 4, and the head 6 is installed around the axis 4 so as to rotate in the circumferential direction of the disc 3. Furthermore, the disc 3 has the magnetized sections 31 and 32. Accordingly, a plurality of parts for detecting the rotational displacement of the axis is required, and the axis is also installed to externally protrude from the main body, so that there is a limit to decreasing the size of the galvanometer. That is, there is a limit to making the galvanometer sufficiently small so that it can be installed in the laser projection system of the mobile terminal.

### SUMMARY OF THE INVENTION

Accordingly, the present invention is intended to provide a deflection scanner, in which a magnetic sensor, which is used to detect the rotational displacement of a rotating axis or a reflecting mirror, is installed in a housing, so that it can be manufactured to be small enough to be installed in the laser projection system of a mobile terminal.

Furthermore, the present invention is intended to provide a deflection scanner, which allows the number of parts use to detect the rotational displacement of the rotating axis to be reduced, so that a reduction in costs and in power consumption, attributable to the reduction in the number of parts, can be achieved.

There is provided a deflection scanner for the laser projection system of a mobile terminal according to an embodiment of the present invention, the deflection scanner including an axis member configured to rotate a reflecting mirror for reflecting light beams; a magnetic member installed so as to be fastened to the axis member and configured to form a predetermined magnetic field; and detection means configured to detect the rotational displacement of the axis member by detecting variation in the magnetic field of the magnetic member.

The magnetic member has a division line, by which at least two poles are divided, and the detection means is located opposite the magnetic member.

Furthermore, the detection means is located on a line identical to the division line of the magnetic member.

Furthermore, the output voltage of the detection means, which is generated when the magnetic member rotates in a clockwise direction or a counterclockwise direction, is greater or smaller than a reference output voltage generated when the magnetic member does not rotate and is opposite the division line. Furthermore, the output voltage linearly increases or decreases according to the rotational displacement of the magnetic member.

There is provided a deflection scanner for the laser projection system of a mobile terminal according to another embodiment of the present invention, the deflection scanner including a rotating axis configured to reciprocally rotate a reflecting mirror, which is used to reflect a light beam, by a predetermined angle; a magnet installed to be fastened to the rotating axis and configured to form a predetermined magnetic field; at least one pair of armatures installed at the circumference of the magnet to be spaced apart from each other; at least one detection means configured to detect the rotational displacement of the rotating axis by detecting variation in the magnetic field of the magnet; and a circuit control unit installed such that the detection means and the armatures are electrically connected to each other, and configured to electrically control the armatures using the output voltage of the detection means.

The armatures are disposed to be spaced apart from each other by a predetermined distance at a location at which the detection means and the magnet are opposite each other so that the detection means easily detects the rotational displacement of the magnet.

Furthermore, the magnet has a division line, obtained through division into two poles, that is, hollow, cylindrical N and S poles, the division line being located between a pair of detection means.

Furthermore, the detection means is located on a line identical to the division line of the magnet.

In this case, the detection means is a magnetic sensor that is composed of a hall sensor and a hall chip.

Furthermore, the detection means outputs a predetermined reference voltage when opposite the division line, outputs a voltage that is higher than the reference voltage and gradually increases according to rotational displacement when the magnet rotates to be spaced apart from the N pole, and outputs a voltage that is lower than the reference voltage and gradually decreases according to rotational displacement when the magnet rotates to be spaced apart from the S pole.

In this case, the level of the higher voltage, which is output and gradually increases, and the level of the lower voltage, which is output and gradually decreases, vary linearly.

The output voltage of the detection means falls within the voltage range of 0 to 3.3 V.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic longitudinal section of a deflection scanner according to a preferred embodiment of the present invention;

FIG. 2 is a schematic cross section of the deflection scanner of FIG. 1;

FIGS. 3A, 3B and 3C are diagrams schematically showing the relationship between a magnet and a detection sensor;

FIG. 4 is a schematic perspective view of a conventional galvanometer; and

FIG. 5 is an enlarged view of the disc of the galvanometer of FIG. 4.

### DESCRIPTION OF THE PREFERRED EMBODIMENTS

A deflection scanner for the laser projection system of a mobile terminal according to a preferred embodiment of the present invention is described in detail with reference to the accompanying drawings below.

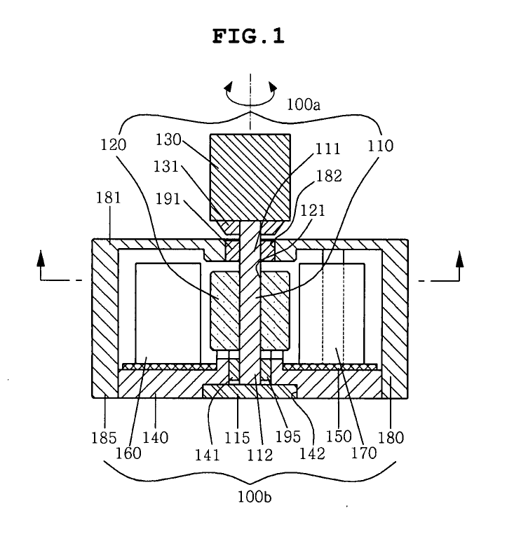

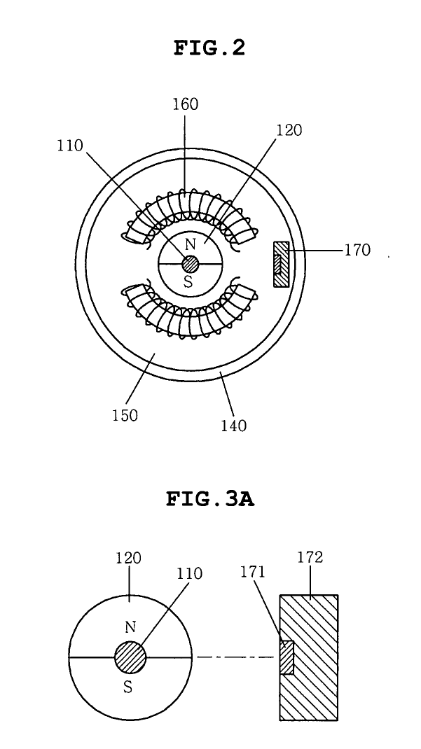

As shown in FIG. 1, the deflection scanner 100 includes a rotating assembly 100a and a fixed assembly 100b.

The rotating assembly 100a is a unified body of parts that are rotated in the deflection scanner 100, and includes a rotating axis 110, a magnet 120 and a reflecting mirror 130.

The rotating axis 110 is used to rotate the reflecting mirror 130, is supported to a base 140 in an axial direction by a washer 115, and is supported such that the output side 111 and the reaction force side 112 of the rotating axis 110 can be rotated by an output side bearing 191 and a reaction force side bearing 195.

The magnet 120 is used to rotate the rotating axis 110 by forming a magnetic field, and a through-hole 121 formed in the axis direction at the center of the magnet 120. The rotating axis 110 passes through the through-hole 121, and is tightly fitted into the through-hole 121 or is bonded to the through-hole 121 using an adhesive agent. Furthermore, the magnet 110 is magnetized to have two poles, that is, an N pole and an S pole.

The reflecting mirror 130 is used to reflect a light beam entering from a light source (not shown), and is installed to be fastened to the end of the output side 111 of the rotating axis 110 by a holder 131. It is preferred that the surface of the reflecting mirror 130 be sufficiently reflective that the light beams can be totally reflected without loss. For example, the reflecting mirror 130 is formed using a polygon mirror, which has a polygonal shape, such as a rectangular, hexagonal or octagonal shape.

The fixed assembly 100b is a unified body of parts that are not rotated in the deflection scanner 100, and includes a base 140, a circuit board 150, armatures 160, a detection sensor 170, a housing 180, an output-side bearing 191, and a reaction force-side bearing 195.

The base 140 supports the installation of the different parts of the deflection scanner 100, and has a circular plate shape. An installation hole 141, into which the rotating axis 110 is inserted, is formed so that it is slightly recessed in the base 140 at the center of the installation hole 141, and another installation hole 142, having a diameter larger than that of the installation hole 141 at the outside of the installation hole 141, is formed to communicate with the installation hole 141.

The circuit board 150 is used to transmit and/or control signals for operating the deflection scanner 100, is installed on the upper surface of the base 140 so as to be located around the installation hole 141, and is electrically connected with an external main board via a cable, which is not shown. The armatures 160 are used to receive external power through the circuit board 150, and form an electric field, and are installed to be fastened to the circuit board 150 at regular intervals around the rotating axis 110 thereof, in greater detail, around the magnet 120 installed along the rotating axis 110. The armatures 160, as is well known, are constructed using a coil bobbin (not shown) fastened to the circuit board 150 and a coil (not shown), wound around the coil bobbin. The coil is electrically connected to the circuit board 150.

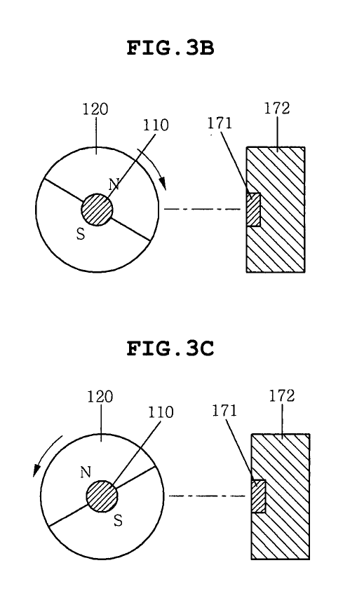

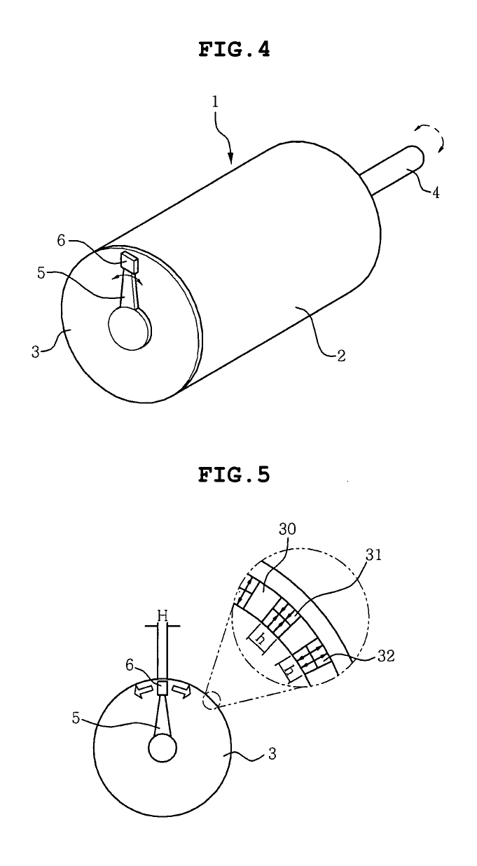

The detection sensor 170 is used to detect the rotational location, that is, the rotational displacement, of the rotating axis 110, and is constructed using a magnetic sensor that reacts to magnetic force. The detection sensor is composed of a hall sensor 171 and a hall chip 172, as shown in FIG. 3. The detection sensor 170 is installed on the circuit board 150 to be located opposite the division line of the N and S poles of the magnet 120 through a gap between a pair of armatures 160 and, preferably, is installed to be located on the same line as the division line or to be tilted in the angular range of about 5 to 10 degrees. The hall chip 172 outputs a predetermined level of voltage per unit of strength of the magnetic field according to the specification thereof. In this case, the performance of the hall chip 172 or the performance of a control circuit depends on the voltage level that is output in sensitive response to variation in the magnetic field. The sensitivity of the control circuit increases as smaller variations in the magnetic field are detected, but the influence of disturbance may increase if the sensitivity increases excessively. Accordingly, it is preferred that the control circuit be designed to have appropriate sensitivity.

The housing 180 is used to protect the parts, which are installed on the base 140, from the outside, is formed in a hollow, cylindrical shape, and has a closed side 181 and an open side 185. A through-hole 182, through which the rotating axis 110 passes, is formed in the center of the closed side 181, and the base 140 is coupled to the open side 185. Here, the base 140 is fitted into the open side 185 of the housing 180, or is bonded into the open side 185 using a specific adhesive agent.

The output-side bearing 191 is used to support the output side of 111 of the rotating axis 110 so that the output side of 111 of the rotating axis 110 can be rotated, and is tightly fitted into the through-hole 182 formed in the closed side 181 of the housing 180.

The reaction force side bearing 195 is used to support the reaction force side 112 of the rotating axis 110 so that the reaction force side 112 of the rotating axis 110 can be rotated, and is tightly fitted into the through-hole 141 formed in the center of the base 140.

The deflection scanner 100 of the present invention, which has the above-described construction, uses a small-sized magnetic sensor as the detection sensor 170 in the detection of the rotational displacement of the reflecting mirror 130, that is, the rotational displacement of the rotating axis 110, and the detection sensor 170 is installed in the housing 180 of the deflection scanner 100, so that the size of the deflection scanner 100 can be reduced enough that it can be easily installed in the laser projection system of the mobile terminal.

A process of detecting the displacement of the rotating axis 110 of the deflection scanner 100 having the above-described construction is described with reference to FIG. 3A to 3C.

When the division line of the N and S poles of the magnet 120 is aligned with the hall sensor 171 of the hall chip 172, as shown in FIG. 3A, the hall chip 172 outputs a predetermined reference voltage.

When the magnet 120, coupled to the rotating axis 110, rotates by a predetermined angle in a clockwise direction and, thereby, the S pole is spaced apart from the hall sensor 171, as shown in FIG. 3B, the hall chip 172 linearly outputs a voltage that is higher than the reference voltage by an amount proportional to the rotation angle.

When the magnet 120, coupled to the rotating axis 110, rotates by a predetermined angle in a counterclockwise direction and, thereby, the N pole is spaced apart from the hall sensor 171, as shown in FIG. 3C, the hall chip 172 linearly outputs a voltage that is lower than the reference voltage by an amount proportional to the rotation angle.

The output value, output as described above, is transmitted to the circuit board 150. The circuit board 150 transmits a signal to the armatures 160 in response to the output value and controls the operation of the deflection scanner 100, that is, the rotating axis 110.

Although, in the present embodiment, various output values may be set according to design, the output voltage of the detection sensor 170 is set to fall within the voltage range of 0 to 3.3 V in consideration of the fact that a mobile terminal generally uses a voltage that falls within the voltage range of 0 to 3.3 V. As described above, it is preferred that the output voltage of a typical detection sensor be equal to or lower than the operation voltage of the terminal. Here, it should be noted that an output voltage higher or lower than the operation voltage of the terminal may be used according to application solutions and operational characteristics.

In accordance with the deflection scanner of the present invention, a small-sized magnetic sensor is used as the detection sensor in the detection of the rotational displacement of the rotating axis, and the detection sensor is installed in the housing, so that the size of the deflection scanner can be reduced enough that it can be easily installed in the laser projection system of the mobile terminal.

Furthermore, the number of parts used to detect the rotational displacement of the rotating axis is reduced compared to the prior art technology, so that a reduction in costs and in power consumption, attributable to the reduction in the number of parts, can be achieved.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A deflection scanner for a laser projection system of a mobile terminal, the deflection scanner comprising:
an axis member configured to rotate a reflecting mirror for reflecting light beams;
a magnetic member installed so as to be fastened to the axis member and configured to form a predetermined magnetic field; and
detection means configured to detect rotational displacement of the axis member by detecting variation in a magnetic field of the magnetic member.

2. The deflection scanner as set forth in claim 1, wherein the magnetic member has a division line, by which at least two poles are divided, and
detection means is located opposite the magnetic member.

3. The deflection scanner as set forth in claim 2, wherein the detection means is located on a line identical to the division line of the magnetic member.

4. The deflection scanner as set forth in claim 2, wherein an output voltage of the detection means, which is generated when the magnetic member rotates in a clockwise direction or a counterclockwise direction, is greater or smaller than a reference output voltage generated when the magnetic member does not rotate and is opposite the division line.

5. The deflection scanner as set forth in claim 4, wherein the output voltage linearly increases or decreases according to rotational displacement of the magnetic member.

6. The deflection scanner as set forth in claim 3, wherein an output voltage of the detection means, which is generated when the magnetic member rotates in a clockwise direction or a counterclockwise direction, is greater or smaller than a reference output voltage generated when the magnetic member does not rotate and is opposite the division line.

7. The deflection scanner as set forth in claim 6, wherein the output voltage linearly increases or decreases according to rotational displacement of the magnetic member.

8. A deflection scanner for a laser projection system of a mobile terminal, the deflection scanner comprising:
a rotating axis configured to reciprocally rotate a reflecting mirror, which is used to reflect a light beam, by a predetermined angle;
a magnet installed to be fastened to the rotating axis and configured to form a predetermined magnetic field;
at least one pair of armatures installed at a circumference of the magnet to be spaced apart from each other;
at least one detection means configured to detect rotational displacement of the rotating axis by detecting variation in a magnetic field of the magnet; and
a circuit control unit installed such that the detection means and the armatures are electrically connected to each other, and configured to electrically control the armatures using output voltage of the detection means.

9. The deflection scanner as set forth in claim 8, wherein the armatures are disposed to be spaced apart from each other by a predetermined distance at a location at which the detection means and the magnet are opposite each other so that the detection means easily detects rotational displacement of the magnet.

10. The deflection scanner as set forth in claim 9, wherein the magnet has a division line, obtained through division into two poles, that is, hollow, cylindrical N and S poles, the division line being located between a pair of detection means.

11. The deflection scanner as set forth in claim 10, wherein the detection means is located on a line identical to the division line of the magnet.

12. The deflection scanner as set forth in claim 10, wherein the detection means is a magnetic sensor that is composed of a hall sensor and a hall chip.

13. The deflection scanner as set forth in claim 11, wherein the detection means is a magnetic sensor that is composed of a hall sensor and a hall chip.

14. The deflection scanner as set forth in claim 10, wherein the detection means outputs a predetermined reference voltage when opposite the division line, outputs a voltage that is higher than the reference voltage and gradually increases according to rotational displacement when the magnet rotates to be spaced apart from the N pole, and outputs a voltage that is lower than the reference voltage and gradually decreases according to rotational displacement when the magnet rotates to be spaced apart from the S pole.

15. The deflection scanner as set forth in claim 14, wherein a level of the higher voltage, which is output and gradually increases, and a level of the lower voltage, which is output and gradually decreases, vary linearly.

16. The deflection scanner as set forth in claim 11, wherein the detection means outputs a predetermined reference voltage when opposite the division line, outputs a voltage that is higher than the reference voltage and gradually increases according to rotational displacement when the magnet rotates to be spaced apart from the N pole, and outputs a voltage that is lower than the reference voltage and gradually decreases according to rotational displacement when the magnet rotates to be spaced apart from the S pole.

17. The deflection scanner as set forth in claim 16, wherein a level of the higher voltage, which is output and gradually increases, and a level of the lower voltage, which is output and gradually decreases, vary linearly.

18. The deflection scanner as set forth in claim 8, wherein the output voltage of the detection means falls within a voltage range of 0 to 3.3 V.
